(19) United States
(12) Patent Application Publication
(10) Pub. No.: US 2023/0033008 A1
(43) Pub. Date: Feb. 2, 2023

(54) ABRADABLE POWDER COATING MANUFACTURED WITH SOLVENT-FREE LIQUID POLYMER RESIN BASE COAT

(71) Applicant: Andrew W. Suman, Waterford, MI (US)

(72) Inventor: Andrew W. Suman, Waterford, MI (US)

(21) Appl. No.: 17/967,146

(22) Filed: Oct. 17, 2022

Related U.S. Application Data
(63) Continuation of application No. PCT/US2021/028674, filed on Apr. 22, 2021.
(60) Provisional application No. 63/013,888, filed on Apr. 22, 2020.

(51) Int. Cl. B05D 3/02; B05D 1/02; C09D 5/03; C09D 163/00; C09D 175/04; C09D 7/61; C09D 7/65

(52) U.S. Cl. CPC B05D 3/0272; B05D 1/02; C09D 5/03; C09D 163/00; C09D 175/04; C09D 7/61; C09D 7/65; B05D 2350/60; B05D 2601/00; B05D 2602/00; B05D 2500/00; B05D 2401/32; B05D 2430/00; B05D 2425/02; B05D 2420/01; B05D 2400/00

(57) ABSTRACT

An abradable coating is formed on a mechanical part from a polymer resin-containing powder deposited over a polymer resin-containing liquid that is substantially free of volatile organic hydrocarbons. The liquid and the powder are then cured together to form an abradable coating. The polymer resin-containing powder may include a first thermosetting resin and a filler having a melting point above a cure temperature of the first thermosetting resin. The interactions of the powder and the liquid result in a durable abradable coating. Because the liquid is substantially free of volatile organic hydrocarbons, overspray may be recovered and used to coat other parts.

### REFERENCE TO RELATED APPLICATION

This Application is a continuation of PCT/US2021/028674 filed Apr. 22, 2021, which claims the benefit of U.S. Provisional Application No. 63/013,888, filed on Apr. 22, 2020, the contents of which are hereby incorporated by reference in their entirety.

### FIELD

The present disclosure relates to abradable coatings of a type used for lubrication, clearance control, and other applications and manufacturing process therefor.

### BACKGROUND

Abradable powder coatings (APCs) may be used as abradable dry film lubricants. U.S. Pat. No. 6,844,392 (the '392 patent) describes a porous coating formed from a powder that is a composite of a polymer resin and a non-melting filler. The coating has been used to provide clearance control in blower rotors and the like. The coating can be applied very thick, even to a thickness that will form an interference fit on initial assembly of the device. Over a break-in period, the coating wears to allow movement between mating parts. After wearing just enough to provide clearance throughout the device's operating temperature range, the coating remains stable. The result is an optimal fit that maximizes efficiency for the life of the device. The porous structure of the coating provides an oil reservoir that helps maintain lubrication.

U.S. Pat. No. 9,534,119 (the '119 patent) describes an abradable coating that includes an upper layer formed from powder and a base layer formed from a liquid base coat. The upper layer may be formed from a powder of the type described in the '392 patent. The liquid base coat includes a polymer resin that cures to form the base layer. By using a liquid base coat and applying the powder over the base coat while it remains liquid, excellent adhesion and structural integrity are achieved. The resulting abradable coating is durable in load bearing applications, making it suitable for piston skirts and the like.

### SUMMARY

In a process according to the '119 patent, a liquid comprising polymer resins and solvent may be sprayed over a mechanical part to form a liquid base coat. A layer of powder is formed over the liquid base coat by electrostatic powder coating while the liquid base coat remains liquid. The liquid base coat and the powder coat are then dried and cured together. Spray coating of the liquid results in much of the liquid being lost to overspray. Due to evaporation of the solvent, the overspray is non-recoverable resulting in waste.

Some aspects of the present teachings relate to a coating process that includes depositing a layer of polymer resin-containing powder over a polymer resin-containing liquid base coat that is substantially free of volatile organic hydrocarbons. The liquid base coat and the powder coating are then cured together to form the abradable coating. The polymer resin-containing powder may include a first thermosetting resin and a filler having a melting point above a cure temperature of the first thermosetting resin. Because the liquid is substantially free of volatile organic hydrocarbons, excess liquid such as overspray that is produced when applying the liquid base coat may be recovered and used to coat other parts.

In some embodiments, individual particles of the powder include both the first thermosetting resin and the filler material. In some embodiments, the powder is the product of a process that includes melt-mixing the first thermosetting resin and the filler material to form a composite, cooling the composite, and breaking up the cooled composite to form the powder. In some embodiments, the filler is employed in an amount from about 15 to about 40 percent based on the volume of the powder. Coatings produced from powder with filler amounts in this range have been found to display favorable balances between strength and abradability. In some of these teachings, the filler is a solid lubricant such as graphite or molybdenum sulfide.

In some of these teachings, curing causes particles of the powder to sinter and flow, but curing completes before the particles entirely lose their individual identities. One consequence of this limited flow is that the resulting coating has roughness that is related to a structure of the particles. The coating has an upper layer that is a cohesive structure formed from the particles. The upper layer extends above a base layer formed from the liquid base coat. In some embodiments, the upper layer has 2-80% porosity. In some embodiments, the upper layer has 10-80% porosity. Coatings with porosity may provide oil reservoirs that help maintain lubrication. The porosity may also contribute to desirable abrasion characteristics.

When the particles are deposited over the liquid base coat while the liquid base coat remains liquid, interactions take place that are evident in the abradable coating post-cure. One such interaction is particles of the powder sinking part way or entirely into the liquid base coat. The sunken portion then becomes encased in a polymer matrix formed from the liquid base coat. The coating may then include a base layer formed from the liquid base coat proximate the surface, an upper layer formed by the sintered particles in a zone distal from the surface, and an interfacial area that includes powder particles that are partially or entirely encased in a polymer matrix formed from the liquid.

In some embodiments, the liquid is wetting with respect to the particles. Wetting, as the term is used here, means the liquid has a contact angle with the solid that is less than 90°. As a result, the liquid creeps upward along the particle surfaces. The resulting configuration may then be preserved by curing. The sinking of the particles into the liquid base coat and the creeping of the liquid up the sides of the particles may improve the structural integrity of the resulting coating. In some embodiments, the liquid is wetting with respect to the surface being coated.

In some embodiments, the liquid is substantially free of any solvent that could partially dissolve the powder particles. Solvents, especially solvents that are volatile organic hydrocarbons, may dissolve or partially dissolve the powder particles that contact the liquid. In the absence of any such solvent, powder particles that contact or become immersed in the liquid base coat may have a same size distribution as particles in a layer above the liquid base coat.

In some of these teachings, the abradable coating includes a base layer formed from the liquid base coat and an upper layer formed only from the particles. In some of these teachings, the upper layer is thicker than the base layer. In some of these teachings, the upper layer is at least three times a thickness of the base layer. In some of these teachings, the upper layer is at least ten times a thickness of the base layer. A primary function of the base layer is adhesion, which does not require much thickness. The upper layer, on the other hand, may have a much greater thickness that improves the fit of mating parts.

Some aspects of the present disclosure relate to an abradable coating that is the product of a process that includes depositing a layer of polymer-resin containing powder over a liquid base coat that is a composition that cures to form a polymer structure and is liquid while being substantially free of volatile organic solvents. While this process was developed to reduce waste, it has been found that the resulting abradable coating provides superior corrosion resistance that is the result of using a substantially solvent-free composition for the liquid base coat. Without wishing to be limited by theory, the applicant notes that the absence of solvent may result in a higher density base coat and provide more consistent contact between the base layer and the substrate in that evaporating solvent may leave small void areas.

The primary purpose of this summary has been to present certain of the inventor's concepts in a simplified form to facilitate understanding of the more detailed description that follows. This summary is not a comprehensive description of every one of the inventor's concepts or every combination of the inventor's concepts that can be considered “invention”. Other concepts of the inventor's will be conveyed to one of ordinary skill in the art by the following detailed description together with the drawings. The specifics disclosed herein may be generalized, narrowed, and combined in various ways with the ultimate statement of what the inventor claims as his invention being reserved for the claims that follow.

### BRIEF DESCRIPTION OF THE DRAWINGS

FIG. 1 is a flow chart of a coating or manufacturing process in accordance with some aspects of the present teachings.

FIG. 2 is a sketch of a part surface with a coating in accordance with some aspects of the present teachings.

FIG. 3 is another sketch of a part surface with a coating in accordance with some aspects of the present teachings.

### DETAILED DESCRIPTION

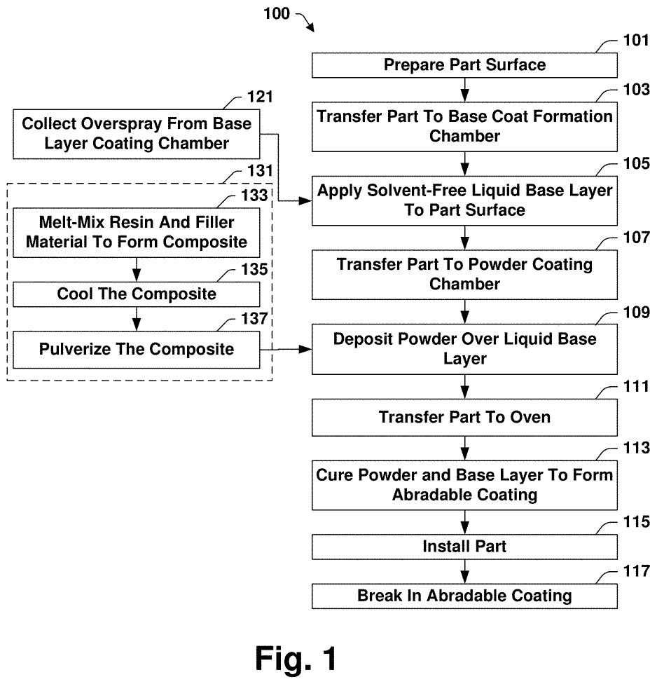

FIG. 1 is a flow chart of an example process 100 for forming a part with an abradable coating according to the present disclosure. Act 101 is preparing a surface of the part that will receive the coat. Examples of parts that may be coated include, without limitation, pistons, rotors, impellers, housings, pump parts, gears, gun parts, compressor parts, projectiles, shafts, shaft seals, and the like. In some embodiments, the part is a machine part that mates with another machine part. The part can be of any material that can withstand the cure temperature of the coating. Example materials of which the part may be made include, without limitation, ceramic, glass, plastic, metal, and the like. In some embodiments, the part is metal. The surface to be coated may already have a coating, porous or non-porous, of any suitable material.

Preparing the surface is optional, although generally advisable. Any surface preparation process or combination of processes may be employed. Examples of surface preparation processes that may be used include physical and chemical processes. Examples of physical preparation processes include, without limitation, vibro-finishing, sanding, abrasive grit blasting, media blasting, plasma treatment, irradiative treatment, and the like. Examples of chemical preparation processes include, without limitation, washing, activating, sealing, and the like. The surface preparation process may form a coating on the surface by chemical, electrochemical, or other means. In some embodiments, surface preparation produces a conversion coating. Examples of conversion coatings include phosphate coatings, chromate coatings, black oxide, and the like. Surface preparation may include electroless plating or electroplating to form alloys of nickel, chrome, tin, or other metals. Surface preparation may include galvanizing or anodizing.

Act 103 is transferring the part to a chamber in which the liquid base coat will be applied to the surface. The surface preparation may take place in the chamber where the liquid base coat is applied and the liquid base coat may be applied without a chamber but having a separate chamber for applying the liquid base coat facilitates forming a clean liquid base coat and recovering excess liquid. In some embodiments, the chamber provides temperature control that may help maintain the liquid in a desired state of flowability.

Act 105 is applying the liquid base coat to the part surface. The liquid base coat is a liquid composition that cures to form a polymer structure and is substantially free of volatile organic solvents. Substantially free of solvents allows for up to 5% solvent provided the solvent is not critical to maintaining liquidity of the liquid base coat. In some embodiments, the liquid base coat is completely free of volatile organic solvent. In some embodiments, the liquid base coat is substantially free of any solvent.

The liquid base coat includes a polymer resin. The term “polymer resin” is used herein to mean any compound or mixture of compounds that can be cured to form a polymer regardless of solidity or viscosity. In some embodiments, the base coat includes one or more epoxy resins that remain liquid without solvent. Examples of epoxy resins that remain liquid without solvent include EPON™ Resin 862 and EPON™ Resin 829, both available commercially from Hexion. EPON™ Resin 862 is a diglycidyl ether produced by reaction of epichlorohydrin with Bisphenol F (BPF or 4,4′-dihydroxydiphenylmethane). EPON™ Resin 829 is derived by reaction of epichlorohydrin with bisphenol A (BPA or (CH₃)₂C(C₆H₄OH)₂). EPON™ Resin 862 may be used by itself or mixed in various ratios with EPON™ Resin 829 to achieve a range of properties. Other examples of solvent-free liquid polymer resins include, without limitation, certain heat-curable urethanes. In some embodiments, the base coat is a relatively low viscosity liquid at the temperature it is applied. A viscosity at or below about 10 Pa*s would be considered a relatively low viscosity. In some embodiments, the viscosity is 2 Pa*s or less.

The liquid base coat may include other components such as diluents, surfactants, modifiers, and other components that either contribute to the formation of the base layer or the functionality of the abradable coating that includes the base layer. Examples of other components that may contribute to the formation of the base layer include, without limitation, curing agents, hardeners, inhibitors, and plasticizers. Examples of other components that may contribute the functionality of the abradable coating include, without limitation, pigments and minerals of various types such as graphite, hexagonal boron nitride, talc, other clays, minerals between 1 and 10 on the scale of MOH's hardness, diamond, cubic boron nitride, metal flake, and the like.

The liquid base coat may be formed by any suitable process. Depending on the composition of the liquid base coat and the type of substrate, suitable processes may include spraying, electrostatic deposition, silk screening, dipping, ink jet printing, brushing, dip spinning, pad printing, film transferring, wiping, and the like. In some embodiments, the process includes some type of spraying. Spraying may be electrostatic spraying. Also, the substrate may be spun during or after spray deposition. The liquid base coat may be formed with multiple layers and the layers may be of different materials.

An additional process may take place after the initial application of the liquid base coat to improve uniformity or coverage. The additional process may include wiping, rinsing, or flinging excess liquid from the surface. In some embodiments, centripetal force is used to fling excess liquid from the surface. Centripetal force can be effective in producing a highly uniform liquid base coat.

Act 121 is an optional step that occurs in parallel with the main process flow. Act 121 is collecting excess liquid from the liquid base layer coating process. In some embodiment, the excess liquid is collected from a liquid base layer coating chamber. The excess liquid may include overspray, drippings, spin castings, residual material on a mesh used for screen printing, or any other material that is dispensed or applied during the process of forming the liquid base layer but ends up in a location other than the surface of a part to be coated. None, part, or all of the material used in act 105 to form the liquid base layer may be excess liquid collected in act 121.

Act 107 is transferring the part with the liquid base coat to another chamber in which the powder coat is applied. The powder coating may take place in the chamber where the liquid base coat is applied and the powder coating may be applied without a chamber, but having a separate chamber for applying the powder coating facilitates containing the powder and avoiding contamination of the excess liquid with powder.

Act 109 is depositing the powder over the liquid base coat. The powder includes a polymer resin and a filler. The resin may be part of a resin system that includes one or more of a curing agent, a hardener, an inhibitor, and a plasticizer. Any suitable thermosetting resin may be used. A thermosetting resin is any polymer resin that can be irreversibly hardened by curing regardless of whether curing is induced by heat, radiation, pressure, catalysis, or any other mechanism. In some embodiments, the thermosetting resin is of a type that can be granulated into a powder. Examples of thermosetting resins that may be used include, without limitation, acrylic, allyl, epoxy, melamine formaldehyde, phenolic, polyamide, polyaryl sulphone, polyamide-imide, polybutadiene, polycarbonate, polydicyclopentadiene, polyester, polyphenylene sulphide, polyurethane, silicone, and vinyl ester resins and mixtures thereof. In some embodiments, the powder has the resin in an amount that is 40 percent or more by volume.

The filler material preferably has a melting point above a cure temperature of the thermosetting resin. In some of these teachings, the filler material is a solid lubricant. Examples of solid lubricants that may be used as the filler material include graphite, PTFE, polyamide, polyamide imide, polyimide, boron nitride, carbon monofluoride, molybdenum disulphide, talc, mica, kaolin, the sulfides, selenides, and tellurides of molybdenum, tungsten, or titanium and combinations thereof. The mixture preferably has the filler material in an amount that is 15 to 40 percent by volume. In some of these teachings the filler is at least 60 percent graphite. In some of these teachings the graphite particles have lengths in the range from 0.1 to 100 μm. In some of these teachings the graphite particles have lengths in the range from 7 to 30 micrometers. Some application benefit from the inclusion of clay in the filler. In some of these teachings, the filler is from 20% to 40% clay by volume. Examples of clays that are suitable for the filler include kaolin, mullite, montmorillonite, and bentonite.

The powder may be the product of a process 131 that includes act 133, melt-mixing the polymer resin and the filler to form a composite, act 135, cooling the composite, and act 137, breaking up the composite to form a powder. The composite may be broken up to form the powder by any suitable process such as milling or the like. The resulting powder preferably has a mean particle size in the range from 2 to 200 μm. For purposes of the present disclosure, particle sizes are the diameters of spheres having the same volume as the particles. More preferably, the mean particle size is in the range from 5 to 150 μm. Still more preferably the particle size is in the range from 10 to 80 μm. Smaller particles may be difficult to process. Larger particles may not adhere well when electrostatics are used. Preferably, the filler and the resin are both present in the individual particles of the powder.

The powder may be deposited over the liquid by any suitable process. In some embodiments, the coating process comprises electrostatics, e.g., electrostatic spray deposition. More generally, the coating process may include one or more of spraying the powder, fluidizing the powder, heating the powder, and heating the surface to be coated. If the surface is heated, it is not heated in a way that solidifies the base layer. It may also be feasible to apply the powder by dipping, rolling, screen printing, or other film transfer process. The powder may be formed into a slurry to facilitate use in one of the foregoing processes.

In some embodiments, act 109 includes depositing multiple layers. Each layer may comprise a different type of powder. The powders may vary in composition, size distribution, or any other characteristic. The different layers may be used in combination to provide desirable wear characteristics and the like.

Act 111 is transferring the part with the powder over liquid base coat to an oven or other apparatus for curing. Alternatively, curing may take place in the chamber where the powder is applied or elsewhere. Curing in a separate chamber such as an oven facilitates recovery and reuse of excess powder.

Act 113 is curing the liquid base layer and the powder to form an abradable coating. Curing hardens the liquid base layer. Curing may be driven by any of heat, radiation, pressure, catalysis, combinations thereof, or any other mechanism. Where curing is driven by heat, heating may take place by convection, conduction, induction, radiative heating, combinations thereof, or any other mechanism. In some embodiments, curing causes the powder to sinter, but curing completes without the particles flowing sufficiently to lose their discrete identities. In some embodiments, curing takes place in a temperature range between 100° C. and 300° C. In some embodiments, curing takes place in a temperature range between 150° C. and 200° C. Curing solidifies the coating. Curing may also consolidate or densify the coating. The various layers of the coating may be cured simultaneously or sequentially.

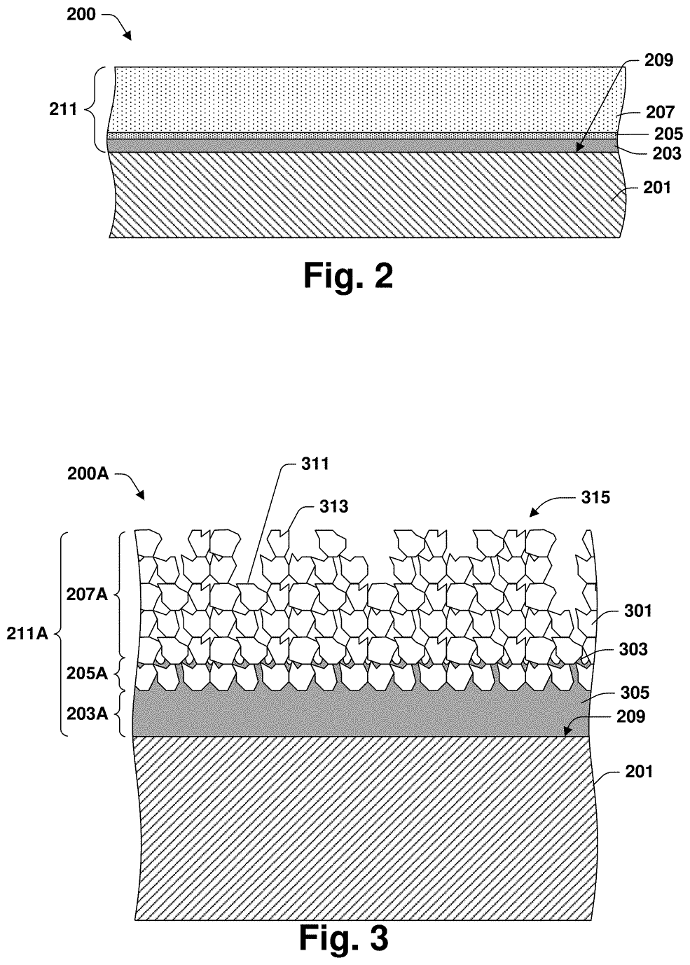

FIG. 2 illustrates a coated part 200 that may be a product of the process of FIG. 1. The coated part 200 includes a substrate 201 and an abradable coating 211 formed on a surface 209 of the substrate 201. The abradable coating 211 includes a base layer 203 formed from a liquid base coat, an upper layer 207 formed from powder particles, and an interfacial area 205 formed from both the liquid base coat and the powder particles.

The base layer 203 is generally non-porous in the sense that neither liquid nor aft can pass through it. In some embodiments, the base layer has 5% or less porosity. In some embodiments, the base layer has less than 2% porosity. In some embodiments, the base layer has no porosity. The base layer 203 includes a polymer matrix and may include one or more non-polymer materials dispersed within the polymer matrix. The base layer 203 adheres the abradable coating 211 to the surface 209 and may serve other functions such as providing corrosion resistance, sealing, and the like for the surface 209.

In some embodiments, the upper layer 207 is porous in the sense that liquid or air can pass through it. The porosity of the upper layer 207 may be in the range from 2 to 80 percent. In some embodiments, the porosity of the upper layer 207 is in the range from 10 to 80 percent. The porosity may facilitate the provision of controlled wear properties, desirable rheological properties, and a reservoir of lubricating fluid. The provision of porosity in the upper layer 207 is facilitated by curing without allowing excessive flow, whereby in some embodiments individual particles of the powder from which the upper layer 207 was formed remain identifiable within the upper layer 207. The upper layer 207 may provide the abradable coating 211 with targeted characteristics such as, for example, friability, lubricity, clearance control capability, absorption or reflection of electromagnetic radiation, phosphorescence, magnetism, heat transport or insulation, and the like. In some embodiments, the upper layer 207 is two or more times thicker than the base layer 203.

In some embodiments, the upper layer 207 includes multiple strata (sublayers) composed of different types of particles. The different strata may be used to control characteristics of the coating. For example, the upper layer 207 may include an upper strata that wears relatively quickly and a lower strata that is comparatively wear resistant to provide a balance between easy break-in and long life.

The interfacial area 205 includes particles of the upper layer 207 partially surrounded or entirely surrounded, partially sunken or entirely sunken, into the polymer matrix of the base layer 203. Fluid-solid interactions may cause the formation of a complex interface. The interfacial area provides adhesion between the upper layer 207 and the base layer 203.

FIG. 3 is a sketch of a coated part 200A, which is an example of the coated part 200 and illustrates possible structure. The coated part 200A includes the substrate 201 and an abradable coating 211A formed on the surface 209 of the substrate 201. The abradable coating 211A includes a non-porous base layer 203A formed from a liquid coat, a porous upper layer 207A formed from powder particles, and an interfacial area 205A formed from both the liquid coat and the powder particles.

The upper layer 207A includes particles 301 that have been sintered enough to flow and bind together to form a solid mass without entirely losing their discrete identities. In other words, the particles 301 may have flowed somewhat, but the flow has been limited so that the abradable coating 211A has structures corresponding to individual particles 301. In particular, an upper surface 315 of the mass may include peaks 313 and valleys 311. The peaks 313 are asperities or smooth bumps depending on the shapes of the particles 301 and the extent to which they have flowed.

The base layer 203A includes a polymer matrix 305. The interfacial area 205A includes particles 301 that are bound by the polymer matrix 305. Some particles 301 may be completely immersed in the polymer matrix 305. Other particles 301 may be partially surrounded by the polymer matrix 305. The particles 301 and the polymer matrix 305 may have a complex interface due to interactions of the liquid base layer and particles of the powder. In some embodiments, those interaction result in a contact structure 303 that is partially determined by a contact angle between the liquid base coat and particles of the powder. FIG. 3 illustrates a structure that may form when the base coat is wetting with respect to the powder particles.

Before break-in, the upper surface 315 has a roughness that is related to a structure of the particles 301. In particular, because the abradable coating 211 cures without the particles 301 flowing sufficiently to entirely loose their discrete identities, the upper surface 315 has peaks 313 that individually correspond to one or more of the particles 301. In some embodiments, before break-in, the upper surface 315 has a roughness Ra in the range from about 0.5 μm to about 20 μm. In some embodiments, before break-in, the upper surface 315 has a roughness Ra in the range from about 1 μm to about 10 μm. In some embodiments, before break-in, the upper surface 315 has a roughness Ra greater than about 2 μm.

After break-in, the upper surface 315 may be smoother. Nevertheless, in some embodiment the upper surface 315 continues to have roughness that relates to the particles 301 retaining a degree of separation. Asperities on the upper surface 315 may be reduced by wear and the surface 315 may recede, but in some embodiments valleys 311 between particles 301 continue to appear of the upper surface 315. In some embodiments, after break-in, the upper surface 315 has a roughness Ra in the range from about 0.2 μm to about 10 μm. In some embodiments, after break-in, the upper surface 315 has a roughness Ra in the range from about 0.5 μm to about 5 μm. In some embodiments, after break-in, the upper surface 315 has a roughness Ra greater than about 1 μm.

The removal of asperities from the upper surface 315 and the appearance of new values 311 as wear continues may result in the valleys 311 having a greater contribution to surface roughness than the peaks 313. This effect is captured by the Rsk of the surface, the Rsk being a roughness parameter that measures the skewness of the of a surface height distribution about a mean. In some embodiments, prior to break-in, the Rsk of the upper surface 315 is in the range from −0.5 to 0.5. In some embodiments, prior to break-in, the Rsk of the upper surface 315 is in the range from −0.25 to 0.25. After break-in these Rsk values are reduced. In some embodiments, after break-in reduces the Rsk be about −0.5 or more. In some embodiments, after break-in, the Rsk is less than about −0.25. In some embodiments, after break-in, the Rsk is less than about −0.50. In some embodiments, after break-in, the Rsk is less than about −1.0.

A structure of the upper surface 315 may also be characterized in terms of the roughness parameters Reduced Peak Height (Rpk) and Reduced Valley Depth (Rvk). Rpk relates to peak height over a surface mean height. Rvk relates to valley depth below the surface mean height. In some embodiments, prior to break in, both Rpk and Rvk are at least about 2 μm. In some embodiments, prior to break in, both Rpk and Rvk are at least about 3 μm. Rvk may remain nearly the same or even increase after break-in. Rpk, on the other hand, may be reduced. In some embodiments, after break-in, the Rpk is less than about 3 μm. In some embodiments, after break-in, the Rpk is less than about 2 μm. In some embodiments, after break-in, the Rpk is half or less than half Rvk. In some embodiments, after break-in, the Rpk is one fourth or less than one fourth Rvk.

Returning to FIG. 1, the process 100 may continue with a break-in process that determines a final shape for the abradable coating 211. Act 115 is installing the part 200 in a machine (not shown), wherein the part 200 may form an interference fit with another part (not shown) of the machine. The coating 211 may initially be thicker than the clearance between the mating parts, whereby a portion of the coating 211 is necessarily shaved off when the part 200 is initially installed.

Act 117 is operating the machine. Operation causes wear at high stress points on the coating 211. As the wear progress, a contact area between the mating parts tends to increase and clearances become optimized, which effects reduce local stresses until the shape of the coating 211 stabilizes.

The components and features of the present disclosure have been shown and/or described in terms of certain embodiments and examples. While a particular component or feature, or a broad or narrow formulation of that component or feature, may have been described in relation to only one embodiment or one example, all components and features in either their broad or narrow formulations may be combined with other components or features to the extent such combinations would be recognized as logical by one of ordinary skill in the art.

1. A process of forming an abradable coating, comprising:
applying a liquid base coat to a first mechanical part;
applying a powder of particles over the liquid base coat while the liquid base coat is liquid; and
curing the liquid base coat and the powder to form an abradable coating on the first mechanical part;
wherein the abradable coating comprises a first layer formed from the liquid base coat below a second layer formed from the powder;
the particles comprise a first thermosetting resin and a filler having a melting point above a cure temperature of the first thermosetting resin; and
the liquid base coat comprises a second thermosetting resin and is substantially free of volatile organic hydrocarbons.

2. The process of claim 1, wherein an extent of flow of the particles during the curing is limited such that the abradable coating has an upper surface with roughness that is related to a structure of the particles.

3. The process of claim 1, wherein curing causes the particles to sinter, but curing completes without the particles flowing sufficiently to entirely lose their discrete identities.

4. The process of claim 1, further comprising:
collecting excess liquid produced when applying the liquid base coat to the first mechanical part;
applying a second liquid base coat including the excess liquid to a second mechanical part;
applying the powder over the second liquid base coat on the second mechanical part; and
curing the second liquid base coat and the powder on the second mechanical part to form an abradable coating on the second mechanical part.

5. The process of claim 1, wherein the liquid base coat is substantially free of solvent.

6. The process of claim 1, wherein the first layer is non-porous.

7. The process of claim 6, wherein the second layer is porous.

8. The process of claim 1, wherein the filler is employed in the particles in an amount from 15 to 40 percent by volume.

9. The process of claim 1, wherein the powder is a product of a process that comprises:
melt-mixing the first thermosetting resin and the filler to form a composite;
cooling the composite; and
breaking up the cooled composite to form powder.

10. The process of claim 1, wherein the liquid base coat comprises an epoxy resin that remains liquid without solvent.

11. The process of claim 1, wherein the second layer has 10-80% porosity.

12. The process of claim 1, wherein some of the particles sink into the liquid base coat.

13. The process of claim 1, wherein the liquid base coat is wetting with respect to the particles.

14. The process of claim 1, wherein the liquid base coat comprises a heat-curable urethane.

15. A coated part, comprising:
a part surface;
a first layer comprising a first polymer adjacent the part surface;
a second layer comprising a structure of particles adhered to one-another, the particles comprising a second polymer; and
an interfacial area where the second layer is joined to the first layer;
wherein the structure of particles comprises particles that are within the interfacial area and particles that are above the interfacial area; and
the particles that are within the interfacial area have a same size distribution as the particles that are above the interfacial area.

16. The coated part of claim 15, wherein the first layer has less than 2% porosity.

17. The coated part of claim 15, wherein the first polymer is of a type that can be formed from a composition of polymer resin that is liquid without solvent.

18. The coated part of claim 15, wherein the first polymer is a product of curing a liquid polymer resin that is liquid while be substantially free of volatile organic hydrocarbons.

19. The coated part of claim 15, wherein the first layer forms contact angles less than 90° with the particles of the structure that are within the interfacial area.

20. The coated part of claim 15, wherein the particles comprise 15%-40% filler material.
